(19) United States
(12) Patent Application Publication
(10) Pub. No.: US 2005/0181717 A1
(43) Pub. Date: Aug. 18, 2005

(54) Hand operated shirring machine

(75) Inventor: Ennio Mercuri, Burnside (AU)

Correspondence Address: CROWELL & MORING LLP;INTELLECTUAL PROPERTY GROUP, P.O. BOX 14300, WASHINGTON, DC, 20044-4300, US

(73) Assignee: Meatech Pty Ltd, Holden Hill , South Australia (AU)

(21) Appl. No.: 10/506,494

(22) PCT Filed: Mar. 4, 2003
(86) PCT No.: PCT/AU03/00263

(30) Foreign Application Priority Data
Mar. 4, 2002 (AU) PS 0835

(51) Int. Cl. A22C 13/02

(52) U.S. Cl. 452/24; 452/150

(57) ABSTRACT

A hand-operated machine for shirring casing onto a stuffing tube (1) includes a body through which the stuffing tube (1) covered in casing may pass. The shirring machine has casing engaging means (4) that engages the casing as the machine is pushed along the stuffing tube (1) from the discharge end (12) so that the casing is drawn onto the stuffing tube. The casing engaging means (4) also disengages the casing when it is pulled in the opposite direction. The shirring machine also includes grasping means (11) to manually move it back and forth along the stuffing tube (1).

### FIELD OF THE INVENTION

This invention relates to a hand operated shirring machine and in particular to a hand operated machine used to load casing material on the stuffing tube of a food packaging machine.

### BACKGROUND OF THE INVENTION

Food packaging machines that are used to produce continuous or discontinuous food products such as salamis or whole muscle product encased in netting force the food product through a stuffing tube so that it is extruded or forced into packaging that is drawn off the stuffing tube. In the case of salami, moistened casing material is fed onto the outer surface of the stuffing tube. This is known as shirring the casing onto the stuffing tube. The end of the casing is clipped and then the food product is forced through the stuffing tube so that the case is pulled from the stuffing tube as it is filled by the food product.

It is similar in the case of whole muscled product which is encased in elastic netting. The elastic netting is shirred onto the stuffing tube and drawn off as the product is forced out of the end of the stuffing tube.

At the beginning of each manufacturing process it is necessary to shirr the required amount of casing material, or as much casing material as is possible, onto the stuffing tube. This is normally carried out by hand where the end of the elongate casing material is slid over the end of the stuffing tube with the casing material bunched or shirred onto the stuffing tube. This is obviously a time consuming process and reduces the packaging efficiency of the machine. Alternatively, in some instances it is possible to have removable stuffing tubes which can have packaging material shirred onto the stuffing tube prior to it being placed on the packaging machine. This enables one stuffing tube to be shirred while another is being used on the packaging machine. However, one disadvantage is the increased capital cost of the equipment and also the time required to change over the stuffing tube. In addition, in some processes or with some machines, it is not possible to change the stuffing tube.

Accordingly, it is an object of this invention to provide a convenient means of loading casing material onto the stuffing tube and for that process to be hand operated.

### SUMMARY OF THE INVENTION

In its broadest form, the invention is a hand operated shirring machine including; a body through which a stuffing tube covered in casing may pass, a casing engaging means that engages said casing as the shirring machine is pushed along said stuffing tube from its discharge end so that said casing is drawn onto said stuffing tube and that disengages from said casing when it is pulled in the opposite direction, and grasping means for grasping said shirring machine to manually move it back and forth along said stuffing tube.

This machine enables casing material to be drawn onto the stuffing tube to its maximum extent and then to release its engagement with the casing so that the machine can be drawn back along the casing over the stuffing tube so that another length of casing can then be engaged and pushed onto the stuffing tube. In this manner, the casing is bunched up in a concertina fashion on the stuffing tube by the shirring machine. This process continues until the stuffing tube is fully covered in bunched casing. The casing can then be cut and the shirring machine removed from the stuffing tube so that the filling process can begin.

The shirring machine may be of a generally tubular shape and may include a hinge and lock mechanism allowing easy placement of the tube about the stuffing tube. The casing engaging means may comprise any form of mechanism which is able to grip the casing when the shirring machine is moved in one direction but release it when it is moved in the opposite direction. It may comprise a plurality of annular segments that are springloaded and slide longitudinally with respect to the tubular body within a tapered section. The tapered section forces the segments towards the stuffing tube so that they grip the casing when it is moved in one direction. The springs release and open the segments when it is moved in the opposite direction.

If the casing comprises an open net, then a plurality of spring-loaded fingers may extend from the end of the tubular body. The fingers may be connected to a continuous circumferential spring which draws the fingers inwardly. Forward movement of the fingers causes them to engage and push the netting forward over the stuffing tube. Rearward movement causes the fingers to move outwardly against the spring force so that the fingers run over the surface of the casing without it being drawn from the stuffing tube. Movement in the opposite direction causes the fingers to engage the casing and again force it onto the stuffing tube.

Preferably, the means for grasping the shir g machine comprise a pair of handles located either side of the tubular body. However, it would be possible to use a single handle together with an abutment surface to enable operation by two hands. In some instances, the machine may be operated by simply grasping the external surface of the tubular body.

### BRIEF DESCRIPTION OF THE DRAWINGS

In order to fully understand the invention, a preferred embodiment will now be described with reference to the following drawings.

FIG. 1 is a cross-sectional view of a preferred embodiment of the present invention.

FIG. 2 is a perspective view of the invention illustrated in FIG. 1 depicting the shirring of netted casing onto a stuffing tube.

FIG. 3 is a top perspective view of the invention illustrated in FIG. 1.

### DESCRIPTION OF PREFERRED EMBODIMENT

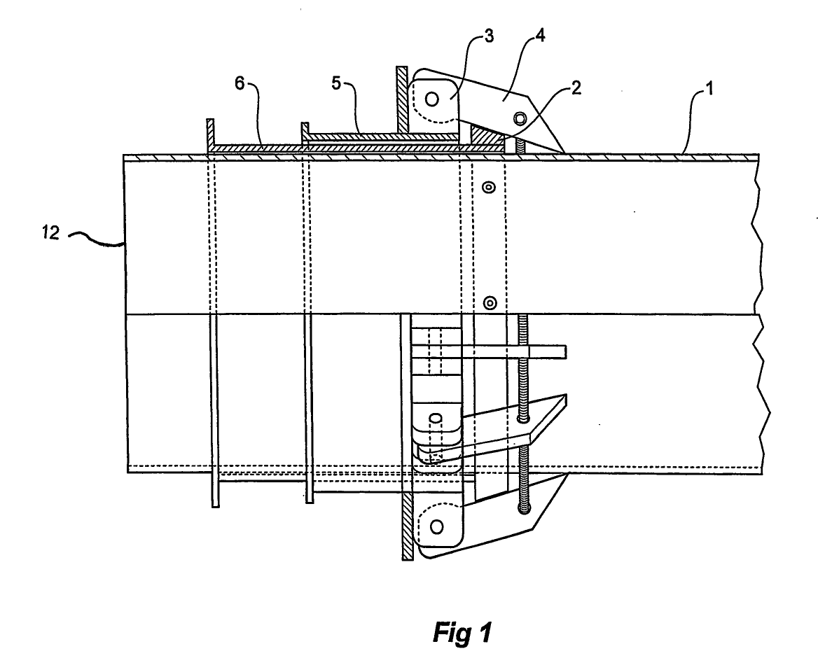

Referring to FIG. 1, the shirring machine is shown located over a stuffing tube 1 having a discharge end 12. The tubular body comprises a first tube 5 that locates over the outer surface of the second tube 6. The second tube 6 locates over the stuffing tube 1. A plurality of mounting brackets 3 are attached to and spaced around the outer surface of the first tube 5. Fingers 4 are pivotally attached to the mounting brackets 3 and extend forward of the first tube 5.

A circumferential coil spring 10 locates through each of the fingers 4 forward of the pivot point of the fingers 4. The coil spring 10 has the effect of drawing the fingers 4 inwardly towards the stuffing tube 1. The first tube 5 slides with respect to the second tube 6. Disengaging means comprising a ring 2 having a tapered exterior section upon which fingers 4 rest is located on the forward end of the second tube 6 and forces the fingers 4 apart as the first tube 5 slides rearwardly with respect to the second tube 6. This enables the fingers 4 to be expanded outwardly so that they can be held clear and disengage from the casing as the machine is placed onto the stuffing tube.

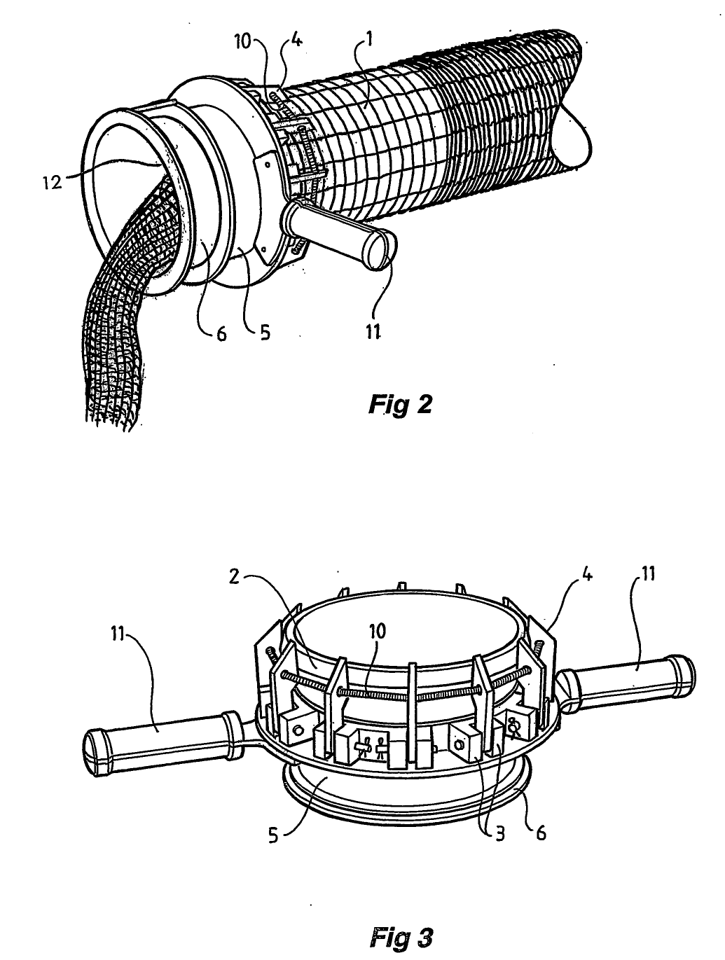

Referring to FIG. 2, fingers 4 are shown engaging the circumferential strands of the netted casing so that as the machine is pushed forward, the netted casing is drawn onto the stuffing tube 1. At the same time, the casing is being bunched up along the length of the stuffing tube 1.

In operation, the first tube 5 is pulled rearwardly with respect to the second tube 6 so that the ring 2 expands the fingers 4 as is shown in FIG. 3. Casing material, in this instance comprising netted casing is drawn through the second tube 6 and pulled over the end of the stuffing tube 1. A tapered mandrel may be temporarily placed at the end of the stuffing tube 1 so that the netted casing can be expanded easily to pull over the end of the stuffing tube 1. The mandrel can remain in place as the netted casing is being loaded.

The machine is then brought onto the end of the stuffing tube 1. The ring 2 holds the fingers 4 open so that the fingers 4 do not at this stage engage the netted casing. The first tube 5 is then pushed forward in relation to the second tube 6 so that the ring 2 is brought into its rearward position in relation to the first tube 5 so that fingers 4 can be pulled by the coil spring 10 into contact with the netted casing. The handles 11 are then used to manually push the shirring machine along the stuffing tube so that the ends of the fingers 4 engage the netted casing and pull it onto the stuffing tube 1. The netted casing in advance of the fingers 4 is bunched up while additional netted casing is being pulled onto the stuffing tube 1.

Once the shirring machine reaches its limit of motion which is governed by the bunched section of netted casing, the machine is pulled rearwardly. The fingers 4 are able to expand and disengage from the netted casing under the action of the coil spring 10 so that the shirring machine can slide over the netted casing. The machine is then ready to be pushed forwardly again. This process is repeated until the stuffing tube 1 is fully covered with netted casing. At the end of this process, the machine is fully removed from the stuffing tube, the netted casing cut and the mandrel removed from the end of the stuffing tube. The netted casing can then be clipped so that the first portion of meat product can be pushed through the discharge end 12 of the stuffing tube. As it is, the casing is drawn from the end of the stuffing tube thereby covering the meat product in netted casing.

As will be seen from the above description, the invention provides a very convenient means of manually loading casing onto a stuffing tube. The invention dearly provides significant advantages in relation to other methods of shirring casing onto a stuffing tube.

It will be understood that the term “comprise” and any of its derivatives (eg. comprises, comprising) as used in this specification is to be taken to be inclusive of features to which it refers, and is not meant to exclude the presence of any additional features unless otherwise stated or implied.

Although a preferred embodiment of the method and apparatus of the present invention has been illustrated in the accompanying drawings and described in the foregoing detailed description, it will be understood that the invention is not limited to the embodiment disclosed, but is capable of numerous rearrangements, modifications and substitutions without departing from the scope of the invention as set forth and defined by the following claims.

1. A hand operated shirring machine including;
a body through which a stuffing tube covered in casing may pass,
a casing engaging means that engages said casing as the shirring machine is pushed along said stuffing tube from its discharge end so that said casing is drawn onto said stuffing tube and that disengages from said casing when it is pulled in the opposite direction, and
grasping means for grasping said shirring machine to manually move it back and forth along said stuffing tube.

2. A hand operated shirring machine as claimed in claim 1 wherein said casing engaging means includes a plurality of annular segments arranged about the circumference of said stuffing tube.

3. A hand operated shirring machine as claimed in claim 1 wherein said casing engaging means includes a plurality of fingers pivotally attached to said body arranged about the circumference of said stuffing tube.

4. A hand operated shirring machine as claimed in claim 3 wherein said fingers are connected to a continuous circumferential spring biased to draw said fingers towards said stuffing tube.

5. A hand operated shirring machine as claimed in claim 1 wherein said casing engaging means includes a spring mounted member located in a tapered section on said body wherein as said member slides longitudinally with respect to said body within said tapered section said member is forced to grip the casing when said member is moved in one direction and release the casing when said member is moved in an opposite direction.

6. A hand operated shirring machine as claimed in claim 1 wherein said body is tubular.

7. A hand operated shirring machine as claimed in claim 1 wherein said body includes a first tubular section having disengaging means,
a second tubular section having casing engaging means interfacing with said tapered portion,
wherein first and second tubular sections are slidably movable a predetermined distance relative to each other so that said casing engaging means is forced to grip said casing when said first and second tubular sections are slid apart from each other and disengaging means acts upon said casing engagement means to release said casing when said first and second tubular sections are slid towards each other.

8. A hand operated shirring machine as claimed in claim 7 wherein said casing engaging means includes a plurality of annular segments arranged about the circumference of said stuffing tube.

9. A hand operated shirring machine as claims in claim 7 said casing engaging means includes a plurality of fingers pivotally attached to said second tubular section arranged about the circumference of said stuffing tube.

10. A hand operated shirring machine as claimed in claim 9 wherein said fingers are connected to a continuous circumferential spring biased to draw said fingers towards said stuffing tube.

11. A hand operated shirring machine as claimed in claim 1 wherein said grasping means include a pair of handles.

12. A method of loading casing onto a stuffing tube comprising:
inserting a tapered mandrel into a discharge end of said stuffing tube;
drawing an end of said casing over said mandrel and sliding said end of said casing onto the discharge end of said stuffing tube;
bringing the hand operated shirring machine as claimed in claim 1 onto the end of said stuffing tube; and
manually operating said hand operated shirring machine to draw casing onto said stuffing tube forming a region of bunched casing away from said discharge end of said stuffing tube.

13-15. (canceled)
